(19) United States
(12) Patent Application Publication
(10) Pub. No.: US 2024/0321501 A1
(43) Pub. Date: Sep. 26, 2024

(54) END COIL COOLING DEVICE

(71) Applicant: HYUNDAI MOBIS CO., LTD., Seoul (KR)

(72) Inventor: Hye Seong YANG, Seoul (KR)

(73) Assignee: HYUNDAI MOBIS CO., LTD., Seoul (KR)

(21) Appl. No.: 18/440,232

(22) Filed: Feb. 13, 2024

(30) Foreign Application Priority Data
Mar. 22, 2023 (KR) 10-2023-0037213

(51) Int. Cl. H01F 27/12; H01F 27/28

(52) U.S. Cl. CPC H01F 27/12; H01F 27/2876

(57) ABSTRACT

Provided is an end coil cooling device coupled to a stator of a motor to cool an end coil extending outward from the stator, the device comprising:
a cooling oil spray unit coupled to each of two ends of the stator in an axial direction to directly spray cooling oil to the end coil and a cooling oil delivery unit coupled with the cooling oil spray unit to deliver external cooling oil to the cooling oil spray unit.

### CROSS-REFERENCE TO RELATED APPLICATIONS

This application claims priority under 35 U.S.C. § 119 to Korean Patent Application No. 10-2023-0037213, filed on Mar. 22, 2023, in the Korean Intellectual Property Office, the disclosure of which is incorporated herein by reference in its entirety.

### TECHNICAL FIELD

The following disclosure relates to an end coil cooling device.

### BACKGROUND

A motor driving an electrified vehicle such as an electric vehicle may include a stator (or a stator core). The stator may use electrical energy received from the outside to generate a magnetic field and rotate a rotor. In recent years, the motor tends to use high voltage/high output to achieve high performance, and a lot of heat may thus occur in a coil receiving high electrical energy. Cooling heat occurring in the coil may have a great influence on performance of the motor, and it is thus important to efficiently reduce heat of the motor.

There are mainly three methods of cooling the motor: water cooling/oil cooling/air cooling. Among these methods, the oil cooling method has been widely used because of the following advantages: the oil cooling may effectively reduce heat by allowing oil to be in direct contact with a heat source, use vehicle oil such as engine oil and reducer oil, and use cooling oil to lubricate the inside of the motor.

However, the oil cooling method requires more accessories and parts such as a pump, a heat exchanger, and an additional pipe, and a more complicated layout, compared to the water cooling method. Among the oil cooling methods, when using a method in which the cooling pipe is inserted into a cooling channel of a housing and oil received by a pressure of the pump is sprayed through a hole in the cooling pipe, oil may be sprayed only to some sections from the outside in a somewhat indirect way rather than being evenly sprayed to all of the inner/outer/upper/lower sides of the coil, and an area of the coil to be directly sprayed through one cooling pipe may thus be somewhat limited. An area of an end coil that is covered by one cooling pipe may be small, thus requiring at least four cooling pipes to spray oil evenly from the outside, requiring one round cooling pipe to spray oil from each of the upper and lower sides, and consuming a large amount of fasteners and bracket parts to fix the cooling pipe, which results in low efficiency in terms of cost reduction, and an increased weight of the motor.

In addition, a large loss of cooling oil may occur even in churning in which oil remaining at a lower part of the motor is lifted to an upper part of the motor by using the rotation and centrifugal force of the rotor. However, the churning is essential in a conventional oil-cooled motor to cool an upper side of the end coil even though such losses occur, and the motor may thus always require more oil than necessary.

### RELATED ART DOCUMENT

### Patent Document

(Patent Document 1) Korean Patent Laid-Open Publication No. 10-2021-0026357 “Motor provided with cooling system” (published on Mar. 10, 2021)

### SUMMARY

An embodiment of the present disclosure is directed to providing an end coil cooling device including a cooling oil spray unit which may directly spray cooling oil to an end coil without a cooling pipe or churning, thereby reducing a production cost, preventing loss of cooling oil, reducing the weight and size of a motor, and maximizing a cooling effect of the end coil.

In one general aspect, provided is an end coil cooling device coupled to a stator of a motor to cool an end coil extending outward from the stator, the device including: a cooling oil spray unit coupled to each of two ends of the stator in an axial direction to directly spray cooling oil to the end coil; and a cooling oil delivery unit coupled with the cooling oil spray unit to deliver external cooling oil to the cooling oil spray unit.

The cooling oil delivery unit may include a curved plate extending to be in contact with a circumference of a side surface of the stator, and the curved plate may include a first groove concavely formed in one surface of the curved plate and delivering cooling oil to the side surface of the stator, and a cooling oil inlet extending from the curved plate and delivering cooling oil to the first groove.

The cooling oil delivery unit may include a flat plate extending from the curved plate in the axial direction of the motor and having an end fitted into the cooling oil spray unit, and the flat plate may include a second groove formed in an extension direction of the flat plate and communicating with the first groove.

The second groove may include a plurality of fine grooves spaced apart from each other by a predetermined distance, and among the fine grooves, the width or depth of the fine groove formed in the center of the second groove may be greater than those of the other fine grooves.

The cooling oil spray unit may be bent to surround a surface of the end coil and extends in an arc shape around a motor axis, include a cooling oil accommodation space accommodating cooling oil, and include two or more spray holes formed in an inner surface in contact with the end coil and communicating with the cooling oil accommodation space.

The cooling oil spray unit may be bent in a U shape to surround the end coil protruding outward from the stator.

The cooling oil accommodation space may be bent in a direction in which the cooling oil spray unit is bent, and have one end into which the cooling oil delivery unit is fitted.

The cooling oil spray unit may extend in the arc shape having a predetermined central angle around the motor axis, and the central angle may be more than 30 degrees and 360 degrees or less.

The cooling oil spray unit may include a rotation restriction protrusion extending outward from a surface of the cooling oil spray unit that is in contact with the stator and fitted into the end of the stator, and the two or more rotation restriction protrusions may be provided, and spaced apart from each other by a predetermined distance in an extension direction of the cooling oil spray unit.

The cooling oil spray unit may include a coil avoidance hole which is formed in one surface and through which the end coil passes, and the coil avoidance hole may include two or more protrusions each fixing the end coil to a side surface of the coil avoidance hole.

### BRIEF DESCRIPTION OF THE DRAWINGS

FIG. 1 is a partial cross-sectional view showing an internal structure of a motor to which an end coil cooling device of the present disclosure is applied.

FIG. 2 is a perspective view showing a curved plate of the present disclosure.

FIG. 3 is a perspective view showing a cooling oil delivery unit of the present disclosure.

FIG. 4 is a perspective view showing the inside of a motor housing to which the cooling oil delivery unit of the present disclosure is applied.

FIG. 5 is a perspective view of the cooling oil spray unit of the present disclosure.

FIG. 6 is a cross-sectional view of the cooling oil spray unit of the present disclosure.

FIG. 7 is a plan view of the cooling oil spray unit of the present disclosure.

FIG. 8 is a partial perspective view of the cooling oil spray unit of the present disclosure.

### DETAILED DESCRIPTION OF EMBODIMENTS

Hereinafter, the spirit of the present disclosure is described in more detail with reference to the accompanying drawings. Prior to the description, terms and words used in the specification and claims are not to be construed as general or dictionary meanings, and are to be construed as meanings and concepts meeting the spirit of the present disclosure based on a principle in which the inventors may appropriately define the concepts of the terms in order to describe their inventions in the best mode.

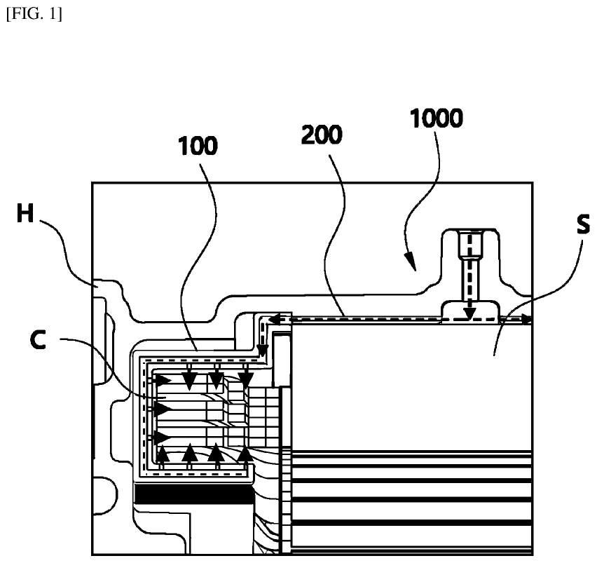

Hereinafter, a basic configuration of an end coil cooling device 1000 of the present disclosure is described with reference to FIG. 1.

The end coil cooling device 1000 of the present disclosure may be coupled to a stator S of a motor to cool an end coil C extending outward from the stator S, and the end coil cooling device 1000 of the present disclosure may include a cooling oil spray unit 100 and a cooling oil delivery unit 200. In more detail, the cooling oil spray unit 100 may be coupled to each of two ends of the stator S in an axial direction to directly spray cooling oil to the end coil C. The cooling oil spray unit 100 may be in contact with the end coil C drawn out of the stator S. In addition, the cooling oil delivery unit 200 may be coupled with the cooling oil spray unit 100 to deliver external cooling oil to the cooling oil spray unit 100. The cooling oil delivery unit 200 may receive cooling oil from the outside of a motor housing H and deliver the same to the cooling oil spray unit 100.

Here, the cooling oil delivery unit 200 may form a cooling channel with a side surface of the stator S, and the cooling oil spray unit 100 may be directly connected to the cooling oil delivery unit 200 to receive cooling oil over the shortest distance. In addition, the cooling oil spray unit 100 may be in contact with the end coil C to directly spray cooling oil to the end coil C. Accordingly, immediately after flowing into the motor housing H, the cooling oil may be moved over the shortest distance to be delivered to the end coil C, and there may be almost no loss of cooling oil because a process such as churning is not required. Ultimately, cooling efficiency may be maximized. In this way, cooling oil sprayed to the end coil C may flow to a lower part of the motor housing H, be cooled by exchanging heat again, and then be delivered to the cooling oil delivery unit 200 again.

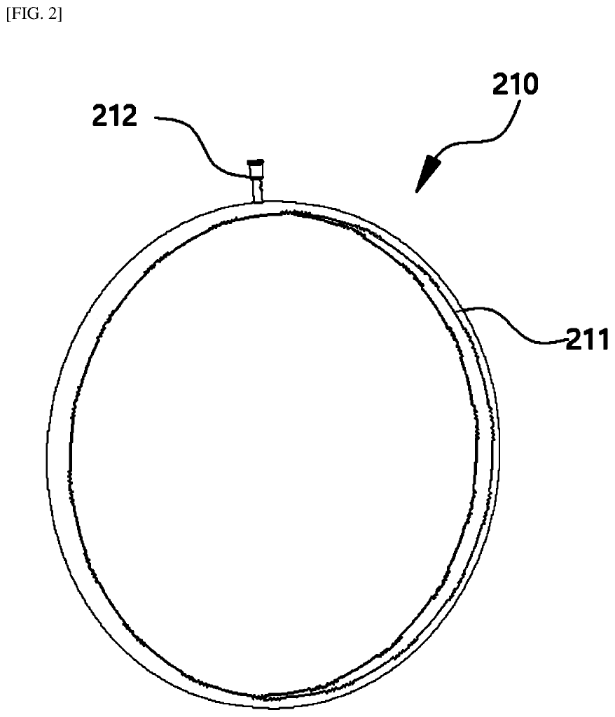

Hereinafter, the cooling oil delivery unit 200 of the present disclosure is described in more detail with reference to FIGS. 2 to 4.

As shown in FIG. 2, the cooling oil delivery unit 200 may include a curved plate 210 extending to be in contact with a circumference of the side surface of the stator S. A first groove 211 may be formed in a surface of the curved plate 210. The first groove 211 may be concavely formed in one surface of the curved plate 210 and deliver cooling oil to the side surface of the stator S. That is, the first groove 211 may be formed in a surface of the curved plate 210 where the curved plate 210 and the side surface of the stator S are in contact with each other, thereby forming the cooling channel surrounded by the first groove 211 and the side surface of the stator S. The first groove 211 may be a closed circuit formed along a diameter of a radial plane corresponding to any point of an axis of the stator S. Accordingly, cooling oil may flow over the shortest distance, and heat exchange between cooling oil and parts other than the end coil C (or a cooling target) may be minimized, thus increasing the cooling efficiency.

In addition, the cooling oil delivery unit 200 of the present disclosure may include a cooling oil inlet 212 extending from the curved plate 210 and delivering cooling oil to the first groove 211. The cooling oil inlet 212 may communicate with a channel formed in the motor housing H to receive cooling oil from the outside of the motor housing H. The cooling oil inlet 212 may communicate with the first groove 211 for the introduced cooling oil to flow on the side surface of the stator S along the first groove 211.

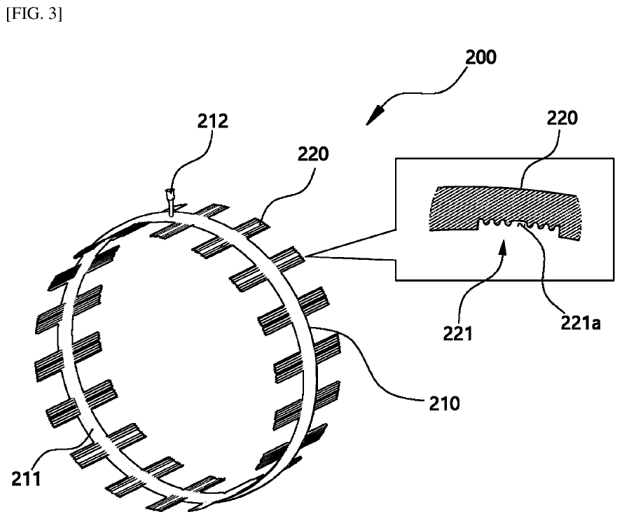

In addition, as shown in FIG. 3, the cooling oil delivery unit 200 may include a flat plate 220 extending from the curved plate 210 in the axial direction of the motor. An end of the flat plate 220 may be fitted into the cooling oil spray unit 100. Similar to the curved plate 210, one surface of the flat plate 220 may be in contact with the side surface of the stator S, and a second groove 221 may be formed in one surface of the flat plate 220. Accordingly, the cooling channel surrounded by the second groove 221 and the side surface of the stator S may be formed. The second groove 221 may be formed in an extension direction of the flat plate 220 and may communicate with the first groove 211.

In more detail, the second groove 221 may include a plurality of fine grooves 221a spaced apart from each other by a predetermined distance. The fine grooves 221a included in the second groove 221 may be parallel to each other, spaced apart from each other by a predetermined distance, and may be positioned in a direction parallel to the extension direction of the flat plate 220. In addition, among the fine grooves 221a included in the second groove 221, the width or depth of the fine groove 221a formed in the center of the second groove 221 may be greater than those of the other fine grooves 221a. Accordingly, a main stream of cooling oil may be formed through the fine groove 221a positioned in the center. In addition, resistance applied to cooling oil when cooling oil is sprayed through a fine hole of the cooling oil spray unit 100 may be minimized by allowing cooling oil to be distributed and delivered through the fine groove 221a positioned in an edge of the second groove 221. Alternatively, in one usage case, the fine grooves 221a included in the second groove 221 may be spaced apart from each other by an irregular distance.

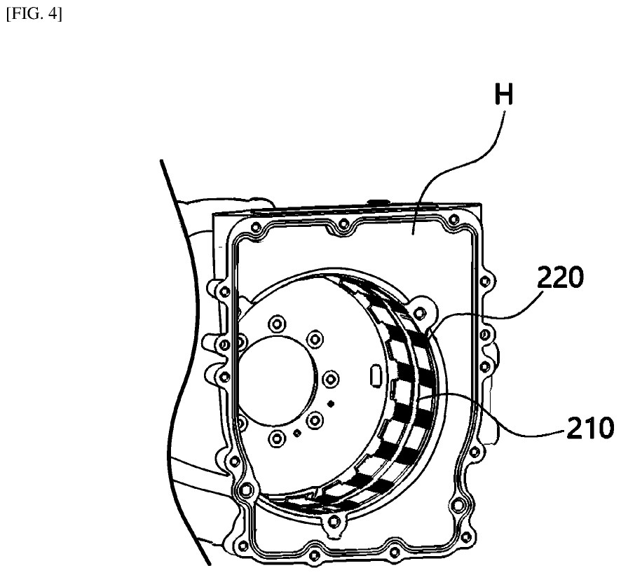

As shown in FIG. 4, the cooling oil delivery unit 200 as described above may be interpolated between the side surface of the stator S and an inner surface of the motor housing H. Here, the cooling oil inlet 212 may communicate with the motor housing H to supply cooling oil to the cooling oil delivery unit 200 from the outside of the motor housing H.

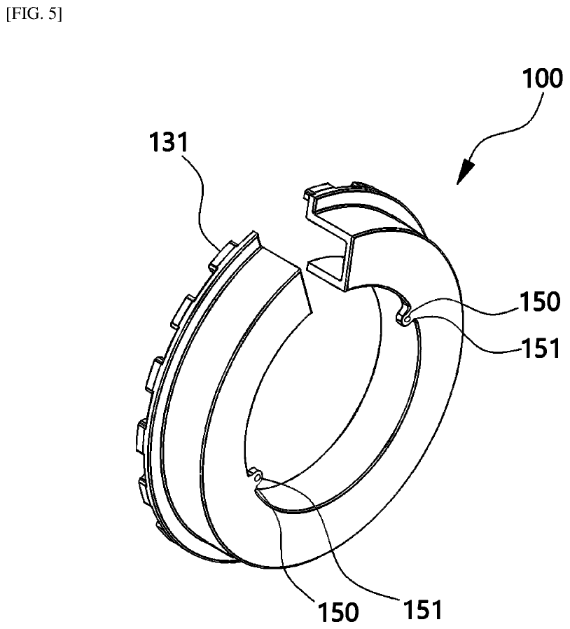

Hereinafter, the cooling oil delivery unit 100 of the present disclosure is described in more detail with reference to FIGS. 5 to 8.

As shown in FIG. 5, the cooling oil spray unit 100 may be bent to surround a surface of the end coil C. In more detail, the cooling oil spray unit 100 may be bent in a U shape to surround the end coil C protruding outward from the stator S. In addition, the cooling oil spray unit 100 may extend in an arc shape around a motor axis. That is, the cooling oil spray unit 100 may extend in the arc shape, and have a cross section bent into the U shape when cut into a plane including the motor axis. The cooling oil spray unit 100 may extend in the arc shape having a central angle more than 30 degrees and 360 degrees or less, and a size (or extension length) of the central angle may be appropriately changed and applied based on a usage case within the above-described range.

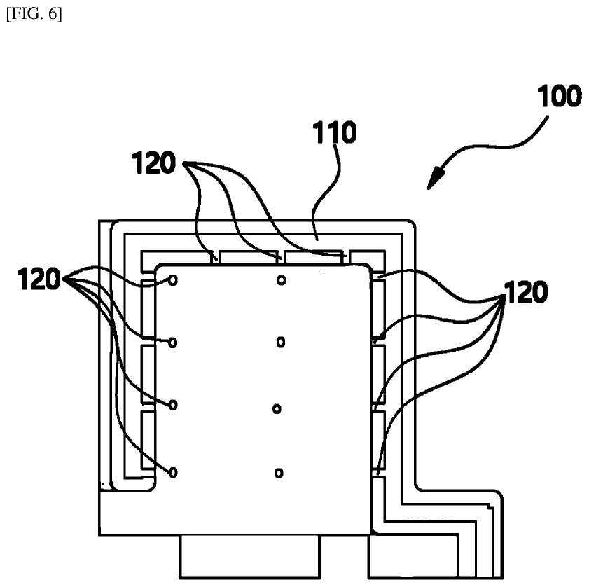

In addition, as shown in FIG. 6, the cooling oil spray unit 100 may include a cooling oil accommodation space 110 accommodating cooling oil. The cooling oil accommodation space 110 may be formed in the bent shape of the cooling oil spray unit 100. That is, the cooling oil accommodation space 110 may be bent in the U shape. In addition, the cooling oil spray unit 100 may include two or more spray holes 120 communicating with the cooling oil accommodation space 110 and the outside of the cooling oil spray unit 100. Cooling oil flowing in the cooling oil accommodation space 110 may be sprayed to the end coil C through the spray hole 120.

In addition, the flat plate 220 may be fitted into one end of the cooling oil accommodation space 110, and a point where the flat plate 220 is fitted into and the cooling oil accommodation space 110 may be spaced apart from each other by a predetermined distance in a radial direction of the stator S. That is, the cooling oil spray unit 100 may be bent to correspond to the shapes of the stator S and the end coil C.

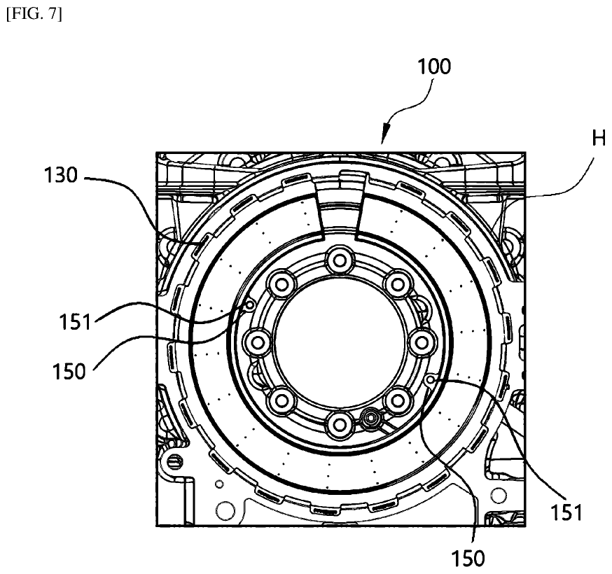

Furthermore, as shown in FIG. 7, the cooling oil spray unit 100 may include a rotation restriction protrusion 130 extending outward from the surface of its bent part that is in contact with the stator S and fitted into the end of the stator S. The rotation restriction protrusion 130 may intersect with protrusions formed in the motor housing H and may be assembled with the protrusions.

The rotation restriction protrusion 130 may extend from its point in contact with the end coil C to its point in contact with the side surface of the stator S (that is, the edge of the stator S). Two or more rotation restriction protrusions 130 may be provided, and spaced apart from each other by a predetermined distance in an extension direction of the cooling oil spray unit 100. A hole into which the flat plate 220 of the cooling oil delivery unit 200 is fitted may be formed in the rotation restriction protrusion 130. That is, the rotation restriction protrusion 130 may not only serve to be connected with the cooling oil delivery unit 200 delivering cooling oil from the side surface of the stator S but also simultaneously serve to restrict a rotation of the cooling oil spray unit 100.

In addition, the cooling oil spray unit 100 may include a bracket 150 extending by a predetermined length in an opposite direction (closer to the motor axis) to a direction in which the rotation restriction protrusion 130 extends, and a screw hole 151 may be perforated in the bracket 150. Accordingly, the cooling oil spray unit 100 may be bolted to the motor housing H.

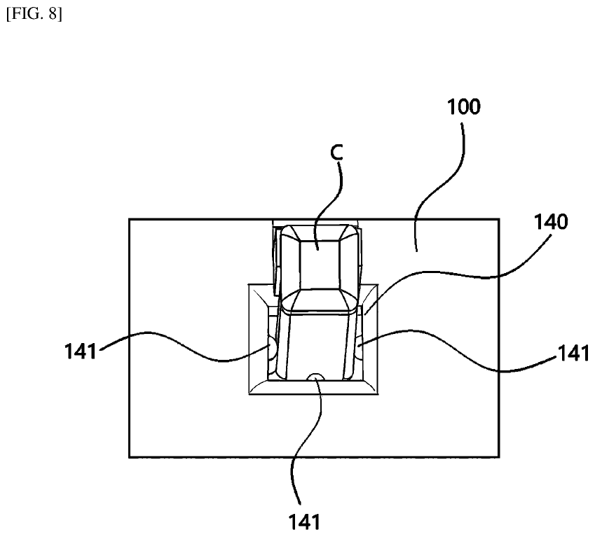

In addition, as shown in FIG. 8, the cooling oil spray unit 100 may include a coil avoidance hole 140 which is formed in one surface and through which the end coil C passes. In more detail, only the cooling oil spray unit 100 coupled to a front side of the stator S may include the coil avoidance hole 140. For the front side of the stator S, the coil may need to be drawn out to be connected to an external terminal assembly. Therefore, the coil avoidance hole may be formed in the cooling oil spray unit 100 for the cooling oil spray unit 100 not to interfere with an extension path of the coil.

In addition, the coil avoidance hole 140 may be formed in a surface positioned in the center of the U-shaped bent surface of the cooling oil accommodation space 110. Accordingly, the end coil C may pass through the cooling oil spray unit 100 without being bent and be connected to the external terminal assembly. In addition, the coil avoidance hole 140 may include two or more protrusions 141 each fixing the end coil C to a side surface of the coil avoidance hole 140. Accordingly, a position of the end coil C may be fixed. Here, the protrusion 141 may have a shape enabling the protrusion 141 to have a predetermined curvature to minimize damage to the end coil C. Two or more coil avoidance holes 140 may be provided, and may be spaced apart from each other by a predetermined distance in the extension direction of the cooling oil spray unit 100.

The end coil cooling device 1000 of the present disclosure may include the coil avoidance structure and the coil guide structure, as described above, thereby stably fixing the position of the coil, and thus serving to prevent damage to a coil-busbar welding part occurring due to vibration of the coil in domestic ES and the like. In addition, the end coil cooling device 1000 of the present disclosure may help to ensure that the motor to which the end coil cooling device 1000 of the present disclosure is applied meets standards of some countries having harsh vibration test laws.

As set forth above, the end coil cooling device of the present disclosure having the above configuration may include the cooling oil spray unit which may directly spray cooling oil to the end coil without the cooling pipe or the churning, thereby reducing the production cost, preventing the loss of cooling oil, reducing the weight and size of the motor, and maximizing the cooling effect of the end coil.

The spirit of the present disclosure should not be interpreted as being limited to the embodiments described above. The present disclosure may be applied to various fields and may be variously modified by those skilled in the art without departing from the scope of the present disclosure claimed in the claims. Therefore, it is obvious to those skilled in the art that these alterations and modifications fall within the scope of the present disclosure.

What is claimed is:

1. An end coil cooling device coupled to a stator of a motor to cool an end coil extending outward from the stator, the device comprising:
a cooling oil spray unit coupled to each of two ends of the stator in an axial direction to directly spray cooling oil to the end coil; and
a cooling oil delivery unit coupled with the cooling oil spray unit to deliver external cooling oil to the cooling oil spray unit.

2. The device of claim 1, wherein the cooling oil delivery unit includes a curved plate extending to be in contact with a circumference of a side surface of the stator, and
the curved plate includes:
a first groove concavely formed in one surface of the curved plate and delivering cooling oil to the side surface of the stator; and
a cooling oil inlet extending from the curved plate and delivering cooling oil to the first groove.

3. The device of claim 2, wherein the cooling oil delivery unit includes a flat plate extending from the curved plate in the axial direction of the motor and having an end fitted into the cooling oil spray unit, and
the flat plate includes a second groove formed in an extension direction of the flat plate and communicating with the first groove.

4. The device of claim 3, wherein the second groove includes a plurality of fine grooves spaced apart from each other by a predetermined distance, and
among the fine grooves, a width or depth of the fine groove formed in a center of the second groove is greater than those of the other fine grooves.

5. The device of claim 1, wherein the cooling oil spray unit is bent to surround a surface of the end coil and extends in an arc shape around a motor axis,
the cooling oil spray unit includes a cooling oil accommodation space accommodating cooling oil, and
the cooling oil spray unit includes two or more spray holes formed in an inner surface in contact with the end coil and communicating with the cooling oil accommodation space.

6. The device of claim 5, wherein the cooling oil spray unit is bent in a U shape to surround the end coil protruding outward from the stator.

7. The device of claim 6, wherein the cooling oil accommodation space is bent in a direction in which the cooling oil spray unit is bent, and has one end into which the cooling oil delivery unit is fitted.

8. The device of claim 5, wherein the cooling oil spray unit extends in the arc shape having a predetermined central angle around the motor axis, and
the central angle is more than 30 degrees and 360 degrees or less.

9. The device of claim 5, wherein the cooling oil spray unit includes two more rotation restriction protrusions, a rotation restriction protrusion of the two more rotation restriction protrusions extending outward from a surface of the cooling oil spray unit that is in contact with the stator and fitted into the end of the stator, and
the two or more rotation restriction protrusions are provided, and spaced apart from each other by a predetermined distance in an extension direction of the cooling oil spray unit.

10. The device of claim 5, wherein the cooling oil spray unit includes a coil avoidance hole which is formed in one surface and through which the end coil passes, and
the coil avoidance hole includes two or more protrusions each fixing the end coil to a side surface of the coil avoidance hole.
